(19) United States
(12) Patent Application Publication
(10) Pub. No.: US 2026/0073485 A1
(43) Pub. Date: Mar. 12, 2026

(54) SCANNING ELECTRON MICROSCOPE (SEM) IMAGE IMPROVEMENT METHOD

(71) Applicant: Samsung Electronics Co., Ltd., Suwon-si (KR)

(72) Inventors: Dongeun Kim, Suwon-si (KR); Jinchoel Choi, Suwon-si (KR)

(21) Appl. No.: 19/056,648

(22) Filed: Feb. 18, 2025

(30) Foreign Application Priority Data
Sep. 10, 2024 (KR) 10-2024-0123428

(51) Int. Cl. G06T 5/70; G06T 5/50; G06T 5/60

(52) U.S. Cl. CPC G06T 5/70; G06T 5/50; G06T 5/60; G06T 2207/10061; G06T 2207/20084; G06T 2207/20221; G06T 2207/30148

(57) ABSTRACT

Provided is a scanning electron microscope (SEM) image improving method including obtaining a plurality of first SEM images by using the SEM, generating a plurality of second SEM images by removing noise from each of the first SEM images, aligning the plurality of second SEM images, and generating a third SEM image by combining the aligned plurality of second SEM images.

### CROSS-REFERENCE TO RELATED APPLICATION

This application is based on and claims ranking under 35 U.S.C. § 119 to Korean Patent Application No. 10-2024-0123428, filed on Sep. 10, 2024, in the Korean Intellectual Property office, the disclosure of which is incorporated by reference herein in its entirety.

### BACKGROUND

The inventive concept relates to a scanning electron microscope (SEM) image improvement method, and more particularly, to an SEM image improvement method by removing noise of the SEM image.

The SEM is one type of electronic microscopes which scan a surface of a sample by using an electron beam (E-beam) and take images of the surface of the sample. The SEM may emit electrons by using a high-speed electron gun, and detect particles such as secondary electrons emerging from the sample after the electrons collide with the surface of an electron sample and interact with the surface.

The SEM may analyze topographical information about a sample surface shape, morphological information about the shape and size of the particles constituting the sample, and crystallographic information such as the arrangement of atoms inside the sample.

The SEM has made it possible to observe unmeasurable microstructures due to the resolution limitation of optical microscopes, and accordingly, has been applied to a wide range of fields, such as medicine, biotechnology, biology, microorganisms, material engineering, and food engineering.

### SUMMARY

The inventive concept provides a scanning electron microscope (SEM) image improvement method capable of improving an SEM image by removing noise of the SEM image. In addition, the issues to be solved by the technical idea of the inventive concept are not limited to those mentioned above, and other issues may be clearly understood by those of ordinary skill in the art from the following descriptions.

According to according to an aspect of the inventive concept, there is provided a scanning electron microscope (SEM) image improvement method including obtaining a plurality of first SEM images by using the SEM, generating a plurality of second SEM images by removing noise from each of the plurality of first SEM images, aligning the plurality of second SEM images, and generating a third SEM image by combining the aligned plurality of second SEM images.

According to another aspect of the inventive concept, there is provided a scanning electron microscope (SEM) image improvement method including obtaining a plurality of first SEM images including one frame by using the SEM, generating a plurality of second SEM images by removing noise from each of the plurality of first SEM images by using machine learning, aligning the plurality of second SEM images, and generating a third SEM image by combining the aligned plurality of second SEM images.

According to another aspect of the inventive concept, there is provided a scanning electron microscope (SEM) image improvement method including obtaining a first SEM image by using a semiconductor process resultant product as a target by using the SEM, generating a plurality of second SEM images by removing noise from each of the plurality of first SEM images by using machine learning, aligning the plurality of second SEM images, and generating a third SEM image by combining the aligned plurality of second SEM images.

### BRIEF DESCRIPTION OF THE DRAWINGS

Embodiments will be more clearly understood from the following detailed description taken in conjunction with the accompanying drawings in which:

FIG. 1 is a schematic flowchart of a scanning electron microscope (SEM) image improving method according to an example embodiment;

FIG. 2 is a schematic diagram of an auto-encoder/decoder;

FIG. 3 is an example diagram of a process of generating a plurality of second SEM images by removing noise of each of a plurality of first SEM images;

FIG. 4 is a schematic flowchart of an operation of aligning the plurality of second SEM images in FIG. 1;

FIG. 5 is an example diagram of an operation of aligning the second SEM images;

FIG. 6 is an example diagram of an operation of combining the aligned second SEM images;

FIG. 7 is a schematic configuration diagram of an SEM used in example embodiments of the inventive concept; and

FIG. 8 is a schematic block diagram of a processor in FIG. 7.

### DETAILED DESCRIPTION OF THE EMBODIMENTS

Hereinafter, embodiments of the inventive concept will be described in detail with reference to the accompanying drawings. Identical reference numerals are used for the same constituent elements in the drawings, and duplicate descriptions thereof are omitted.

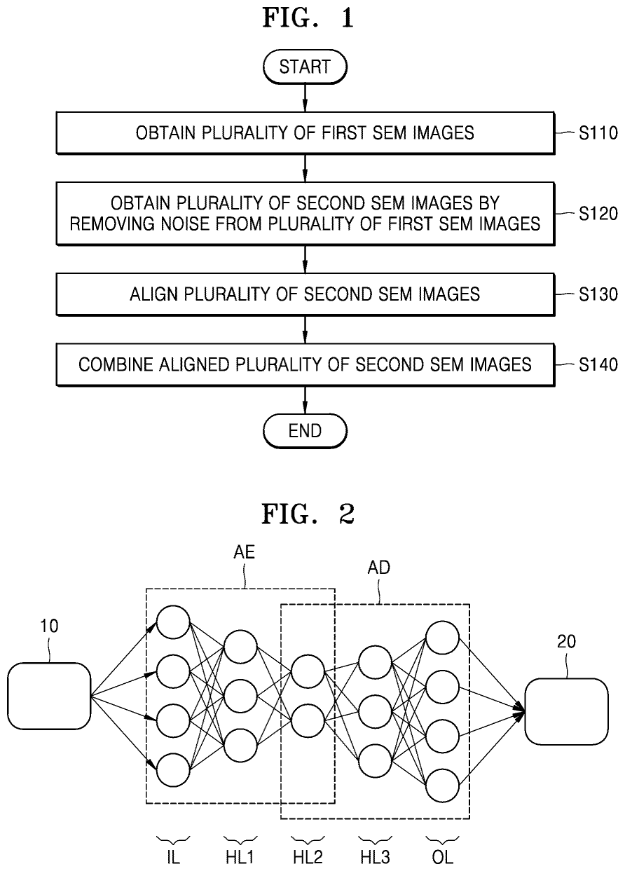

FIG. 1 is a schematic flowchart of a scanning electron microscope (SEM) image improving method according to an example embodiment.

Referring to FIG. 1, the SEM image improving method according to an embodiment may include obtaining a plurality of first SEM images (S110), obtaining a plurality of second SEM images (S120), aligning the plurality of second SEM images (S130), and combining the aligned second SEM image (S140).

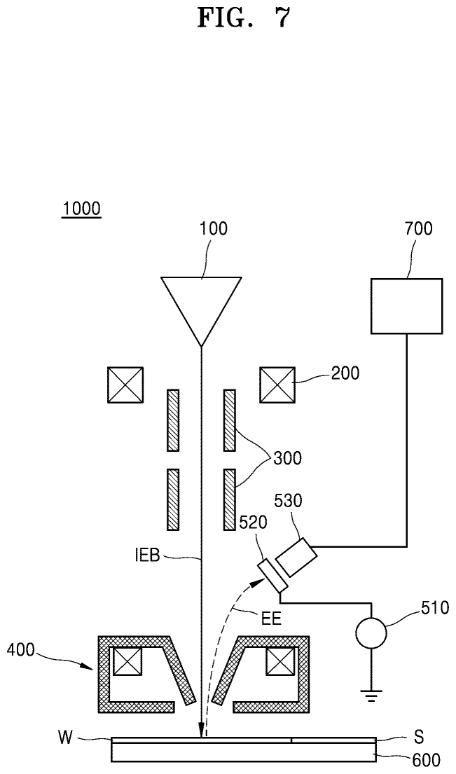

The operation of obtaining the plurality of first SEM images (S110) may obtain the plurality of first SEM images by using an SEM (refer to SEM 1000 in FIG. 7). The first SEM image may mean an image generated from emitted electrons EE emitted from a sample of a structure specimen S. For example, the first SEM image may be generated by irradiating an input electron beam IEB onto each sample of the structure specimen S, and detecting emitted electrons EE emitted from each sample by using a detector 530. The SEM 1000 is described in detail with reference to FIG. 7.

Each first SEM image may include one frame obtained by a one-time irradiation of the SEM 1000. As described above, the SEM image may include an image generated by detecting, using the detector 530, the emitted electrons EE emitted from the sample onto which the input electron beam IEB has been irradiated by an electron gun 100 of the SEM 1000. One frame image may be formed by the emitted electrons EE emitted by irradiating the input electron beam IEB one time onto all or a portion of the sample. In general, one SEM image may be formed by forming several frame images of the same area of the sample and merging them.

In the inventive concept, each of the plurality of first SEM images may include one frame image formed by the emitted electrons EE emitted by irradiating the input electron beam IEB onto all or a portion of the sample one time.

Each first SEM image may include an image obtained by using the SEM 1000 with respect to a semiconductor process resultant product. The semiconductor process resultant product may be formed during the semiconductor process, that is, in or at the end of the semiconductor process. The semiconductor process resultant product may have countless patterns. A non-pattern area having a uniform vertical level but having no pattern may be between the countless patterns provided in the semiconductor process resultant product.

After the plurality of first SEM images are obtained, the plurality of second SEM images from which noise has been removed may be obtained (S120). In other words, in the operation of generating the plurality of second SEM images by removing noise (S120), the plurality of second SEM images may be generated by removing noise from each of the plurality of first SEM images by using machine learning. Each second SEM image may include an image from which noise has been removed from a corresponding first SEM image including one frame image.

The machine learning may be used to remove noise from the first SEM image. The machine learning may use, for example, an auto-encoder/decoder.

FIG. 2 is a schematic diagram of the auto-encoder/decoder. Referring to FIG. 2, the auto-encoder/decoder may include an auto-encoder AE and an auto-decoder AD.

The auto-encoder AE may receive the first SEM image, and perform encoding (or compression) on the first SEM image. For example, the auto-encoder AE may include an input layer IL, a first hidden layer HL1, and a second hidden layer HL2.

The input layer IL may include input neurons, and the input neurons may respectively receive corresponding values from the first SEM image. The input neurons may be respectively connected to hidden neurons of the first hidden layer HL1. In this case, in a process of transmitting information between the input layer IL and the first hidden layer HL1, a weight may be applied between each of the neurons, and information about the first SEM image may be encoded (or compressed) according to the weight.

Similarly, a weight may be applied between each of the neurons in the process of transmitting information between the neurons of the first hidden layer HL1 and the second hidden layer HL2. Finally, the auto-encoder AE may generate information of a compressed form with respect to the first SEM image.

The auto-decoder AD may decode information in a compressed form with respect to the first SEM image that has been generated by the auto-encoder AE. For example, the auto-decoder AD may include a second hidden layer HL2, a third hidden layer HL3, and an output layer OL.

Similar to the description given above, by applying a weight to hidden neurons between the second and third hidden layers HL2 and HL3, and applying a weight to hidden neurons of the third hidden layer HL3 and output neurons of the output layer OL, a second SEM image 20 may be finally output.

The second SEM image 20 may have a form in which noise of a first SEM image 10 is removed. In other words, by encoding/decoding the first SEM image 10 by using the auto-encoder/auto-decoder, noise of the first SEM image 10 may be removed.

In an embodiment, weights used in the auto-encoder/auto-decoder may be adjusted by using un-supervised learning. In other words, the weights described above may be learned or determined, by performing auto-encoding and auto-decoding on the first SEM image 10.

Although not clearly illustrated in the diagram, the number of hidden layers in FIG. 2 may be variously modified. In addition, the number of neurons included in the input layer IL, the hidden layer HL, and the output layer OL may be variously modified.

In the embodiment, the auto-encoder/auto-decoder are described with reference to FIG. 2, but the embodiment is not limited thereto. The auto-encoder/decoder may be replaced by a characteristics learning model, such as convolution autoencoder (CAE), variational autoencoder (VAE), and generative adversarial network (GAN).

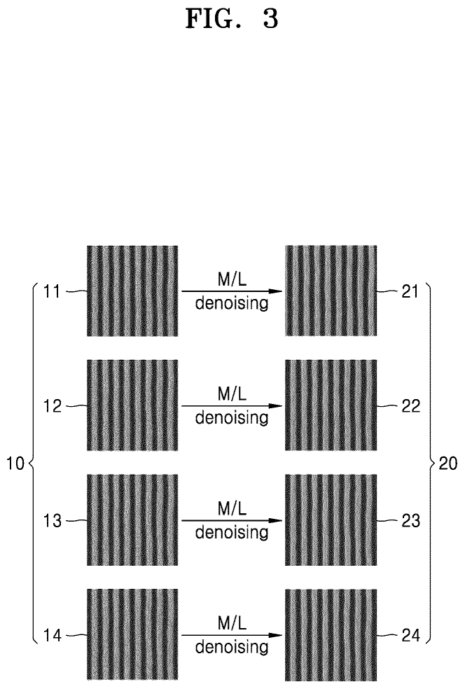

FIG. 3 is an example diagram of a process of generating the plurality of second SEM images by removing noise from each of the plurality of first SEM images. As shown in FIG. 3, the plurality of first SEM images 10 may include first SEM images 11 to 14, and the plurality of second SEM images 20 may include second SEM images 21 to 24.

Referring to FIG. 3, each of first SEM images 11 through 14 may include a single frame. Each of the first SEM images 11 through 14 including a single frame may have noise. According to the embodiment, noise may be individually removed from each of the first SEM images 11 through 14 to generate second SEM images 21 through 24. Machine learning denoising (M/L denoising) may be used as described above to remove noise from each of the first SEM images 11 through 14.

After all of the first SEM images 11 through 14 are combined to form one SEM image, noise may be removed from the combined SEM image. However, compared to the case where noise is removed after the SE images are combined, removing noise from each SEM image having a single frame before combining as described in the inventive concept and combining the SEM images with noise removed therefrom may have higher noise removal performance.

After the second SEM image with noise removed therefrom is obtained, the plurality of second SEM images may be aligned (S130). The operation of aligning the plurality of second SEM images 21 through 24 (S130) may set any one of the plurality of second SEM images 21 through 24 as a reference image, set other second SEM images as input images, and align the reference image with the input image such that a mean squared error (MSE) between the reference image and the input image becomes a minimum while the input image is relatively moved with respect to the reference image.

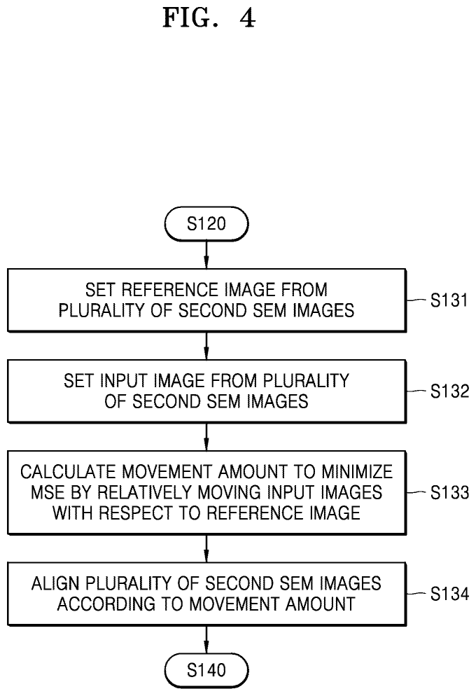

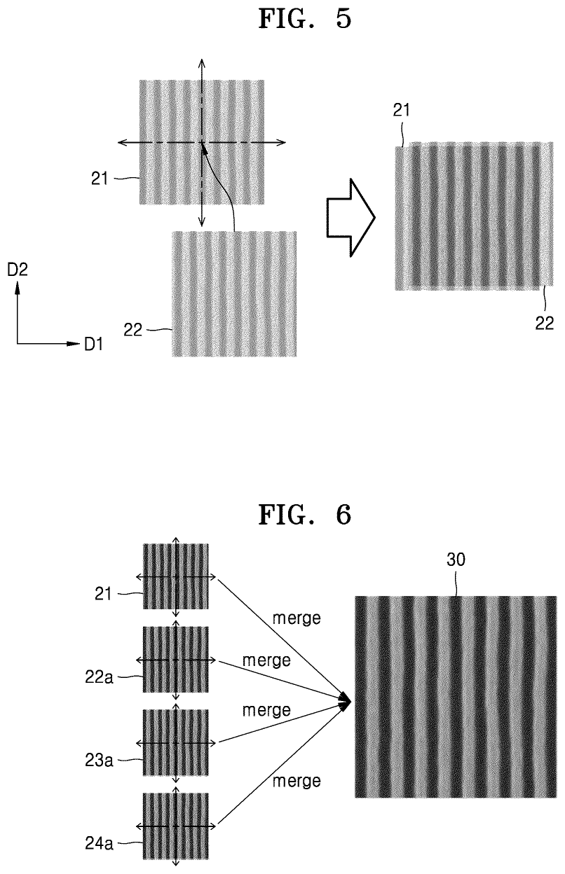

FIG. 4 is a schematic flowchart of an operation of aligning the plurality of second SEM images in FIG. 1. FIG. 5 is an example diagram of an operation of aligning the second SEM images.

Referring to FIGS. 4 and 5, the operation of aligning the plurality of second SEM images (S130) may set any one of the plurality of second SEM images 21 through 24 as the reference image (S131). For example, the second SEM image 21 be set as the reference image among the four second SEM images 21, 22, 23, and 24 from which noise has been removed. The reference image may be used as a reference for alignment with other second SEM images. In other words, the other second SEM images may be aligned as being moved up, down, left, and right in the state where the reference image is fixed.

An arbitrary one among the plurality of second SEM images may be set as the reference image. For example, while the second SEM image 21 is set as the reference image in the example of FIGS. 4 and 5, any of second SEM images 21, 22, 23, and 24 may be used as the reference image.

After the reference image is set, other second SEM images 22, 23, and 24 may be set as input images (S132). When one of the second SEM image 21 is set as the reference image among four of the second SEM images 21 through 24, other second SEM images 22, 23, and 24 may be set as input images.

Next, while an input image is relatively moved with respect to the reference image, a movement amount at which the MSE of the reference image and an input image becomes a minimum may be calculated (S133).

As described above, after one second SEM image 21 among the plurality of second SEM images 21 through 24 is set as the reference image, and one second SEM image 22 among the other second SEM images 22, 23, and 24 except for the reference image is set as an input image, the MSE may be calculated as the second SEM image 22, an input image, is moved in a first direction D1 or a second direction D2 with respect to the second SEM image 21, the reference image.

The second SEM image 22 may be moved at least one pixel with respect to the second SEM image 21. For example, the MSE may be calculated in the state where the second SEM image 21, or the reference image, overlaps the second SEM image 22, or the input image, and then, the MSE may be calculated after the second SEM image 22, or the input image, is moved by one pixel in the first direction D1.

The MSE may be calculated for all movements of the second SEM image 22, or the input image, with respect to the second SEM image 21, or the reference image, and by comparing the MSEs that are calculated, the movement amount of the second SEM image 22, or the input image, to minimize the MSE may be selected. Because the MSE means a difference between the second SEM image 21, or the reference image, and the second SEM image 22, or the input images when the second SEM image 22, or the input image, is moved by the movement amount to minimize the MSE, the second SEM image 21, or the reference image and the second SEM image 22, or the input image, may be in an optimum alignment state.

Whether alignment between the second SEM image 21, or the reference image, and the second SEM image 22, or the input image, is good may be identified.

The MSE may be calculated by using Formula 1 below.

$$M S E ( x , y ) = \frac{{{\sum }_{M \cdot N} [ Ref ( m , n ) - input ( m - x , n - y ) ]}^{2}}{M \cdot N} \qquad Formula 1$$

In this case, Ref(m, n) may be a pixel value of the reference image at a coordinate (m, n), an input (m−x, n−y) may be a pixel value of the input image at a coordinate moved from the coordinate (m, n) by (x, y), M may be the number of pixels in the first direction D1, that is, a longitudinal axis direction, of the reference image, and N may be the number of pixels in the second direction D2, that is, a vertical axis direction of the reference image.

After the movement amount that results in the minimum MSE between the second SEM image 21 and the second SEM image 22 is calculated, this process may be repeated for each of the other second SEM images 23 and 24. For example, one of the other second SEM images 23 and 24, for example, the second SEM image 23, may be selected as the input image, and the movement amount that minimizes the MSE between the selected second SEM image 23, or the input image, and the second SEM image 21 may be calculated. When the second SEM image 23 is moved according to the movement amount, the second SEM image 21, or the reference image, and the second SEM image 23, or the input image, may be in an optimum alignment state.

By selecting the second SEM image 24 as an input image to calculate the MSE of the second SEM image 21, or the reference image, and calculating the movement amount that minimizes the MSE, the optimum alignment state between the second SEM image 21, or the reference image, and the second SEM image 24, or the input image, may be obtained by calculating the movement amount that minimizes the MSE.

After the movement amount at which the MSE is minimized is calculated, by moving the input image according to the movement amount, the input image may be aligned with the reference image (S134). For example, each of the second SEM image 22, 23, and 24 (the input images) are aligned with the second SEM image 21 (the reference image) by moving each of the second SEM image 22, 23, and 24 (the input images) a movement amount at which the calculated MSE is minimized to obtain optimally aligned second SEM images (e.g., second SEM images 22a, 23a, and 24a of FIG. 6).

After the reference image is aligned with the input image, a third SEM image may be generated by combining the reference image and the input images (S140).

FIG. 6 is an example diagram of an operation of combining the aligned second SEM images.

Referring to FIG. 6, the second SEM image 21 may be the reference image, and the remaining second SEM images 22a, 23a, and 24a may include images optimally aligned with the second SEM image 21, which is the reference image. According to the embodiment, a third SEM image 30 may be generated by combining the second SEM image 21, which is the reference image, and the aligned second SEM images 22a, 23a, and 24a.

Because the third SEM image is obtained by removing noise from the first SEM images 11 through 14, which are single frames, before combining, and by combining after aligning the second SEM images 21 through 24 from which noise has been removed, a precise shift compensation between each of the SEM images may be performed, and thus a SEM image of high quality without image blur or resolution deterioration may be obtained.

FIG. 7 is a schematic configuration diagram of the SEM used in example embodiments of the inventive concept.

Referring to FIG. 7, the SEM 1000 may be configured to measure a wafer W. According to embodiments, the SEM 1000 may measure the wafer W, on which the semiconductor device manufacturing process has been performed, by using a scanning method.

According to some embodiments, by measuring the wafer W, the SEM 1000 may obtain topographical information about the wafer W, morphological information about shapes, sizes, or the like of particles constituting the wafer W, and crystallographic information about the arrangement state of atoms in the wafer W or the like.

According to some embodiments, by input electron beam IEB onto the wafer W, and detecting the emitted electrons EE emitted by the wafer W due to interaction between the input electron beam IEB and the wafer W, the SEM 1000 may evaluate the manufacturing process of the semiconductor device that has been performed on the wafer W. The emitted electrons EE may be generated by elastic scattering or may be generated by in-clastic scattering.

The elastic scattering may be a phenomenon in which electrons included in the input electron beam IEB are directed in a direction opposite to the input direction of the input electron beam IEB, without substantial change in the energy of the electrons included in the input electron beam IEB, by the potential of the atomic nuclei constituting the wafer W. Electrons escaping from the surface of the wafer W due to the clastic scattering may be called as backscattered electrons, and the backscattered electrons may have energy of about 50 eV or more. The backscattered electrons may include information about both the structural features and compositional characteristics proximate to the wafer W surface.

In-elastic scattering may be a phenomenon in which electrons included in the atoms in the wafer W are emitted due to interaction with electrons on the electronic orbit of the atoms in the wafer W, when the electrons included in the input electron beam IEB are incident onto the surface of the wafer W. Due to the in-elastic scattering, secondary electrons, Auger electrons, and an X-ray may be emitted. Secondary electrons among the emitted electrons EE may have energy of several electron volts (eV). The secondary electrons may have information about the unevenness near the surface of the wafer W.

The secondary electrons may include electrons which have been restrained by the electrons and released as free electrons, after energy is transferred to the electrons restrained by the electrons in the wafer W due to electrons included in the input electron beam IEB. When electrons at an energy level lower than a valence band are emitted as the secondary electrons, the X-ray may be emitted as electrons at a higher energy level move to a lower energy level, and the electrons emitted from the wafer W that are agitated by the X-ray may include the Auger electrons. The X-ray may include continuum X-ray and characteristic X-ray. The Auger electron and the X-ray may have information about the composition near the surface of the wafer W and chemical bonding.

The SEM 1000 may further detect signals due to incoherent elastic scattering electrons, transmitted electrons, and cathode-luminescence.

The SEM 1000 may include an electron gun 100, a condensing lens 200, a deflector 300, an objective lens 400, a power source 510, an energy filter 520, the detector 530, a stage 600, a processor 700, and the structure specimen S. In example embodiments, the structure specimen S may be a semiconductor device formed on the wafer W.

The electron gun 100 may generate and emit the input electron beam IEB. In an embodiment, the electron gun 100 may be configured to irradiate the input electron beam IEB onto the wafer W and the structure specimen S. The wavelength of the input electron beam IEB may be determined by energy of electrons emitted by the electron gun 100. According to some embodiments, the wavelength of the input electron beam IEB may be several nm. According to some embodiments, the electron gun 100 may be of any one of a cold field emission (CFE) type, a Schottky emission (SE) type, and a thermionic emission (TE) type.

The electron gun 100 may generate the input electron beam IEB by thermally or electrically applying energy greater than a work function (that is, a difference value between the energy level and Fermi energy in a vacuum) to electrons included in a solid material, which is an electron source.

The condensing lens 200 may be arranged on the path of the input electron beam IEB between the electron gun 100 and the wafer W. According to some embodiments, the condensing lens 200 may focus the input electron beam IEB onto the deflector 300. Accordingly, controllability of the input electron beam IEB may be enhanced by the deflector 300.

The deflector 300 may be arranged on the path of the input electron beam IEB between the condensing lens 200 and the wafer W. The deflector 300 may deflect the input electron beam IEB emitted by the electron gun 100. The deflector 300 may deflect the input electron beam IEB so that the input electron beam IEB passes through the condensing lens 200 and the objective lens 400 and is irradiated onto a location set on the wafer W and/or the structure specimen S. According to some embodiments, the deflector 300 may scan the input electron beam IEB on the wafer W and/or the structure specimen S. The deflector 300 may be of any one of an electrical type and a magnetic type.

The objective lens 400 may be arranged on the path of the input electron beam IEB between the deflector 300 and the wafer W. The objective lens 400 may focus the input electron beam IEB on the wafer W and/or the structure specimen S. As the input electron beam IEB is limited in a narrow region on the wafer W and the structure specimen S, resolution of the SEM 1000 may be further enhanced.

In the above, a transmission system of the input electron beam IEB, including the condensing lens 200, the deflector 300, and the objective lens 400 has been described, but this is a non-limiting example and does not limit the technical idea of the inventive concept in any sense. A person of skill in the art will be able to easily reach a transmission system of an input electron beam IEB, including additional focusing lenses and an additional deflector, based on what is described herein.

The power source 510 may supply power for filtering the emitted electrons EE to the energy filter 520. According to some embodiments, the energy filter 520 may include a high-pass filter. According to some embodiments, the energy filter 520 may block electrons having energy less than blocking energy among the emitted electrons EE. The energy filter 520 may adjust the blocking energy by adjusting the power transmitted by the power source 510.

The detector 530 may detect at least some of the emitted electrons EE reflected from the wafer W and/or the structure specimen S. For example, the detector 530 may detect secondary electrons and/or rear scattering particles emitted by the wafer W. According to an example embodiment, the detector 530 may detect some of the emitted electrons EE having passed through the energy filter 520. The energy of the detected emitted electrons EE may be greater than the blocking energy of the energy filter 520. The detector 530 may detect the emitted electrons EE, and obtain the SEM image.

The stage 600 may support the wafer W and the structure specimen S, which are measurement objects. The stage 600 may move the wafer W and/or the structure specimen S in the horizontal and vertical directions, or rotate the wafer W and/or the structure specimen S with respect to the vertical direction as a reference so that the wafer W and/or the structure specimen S are aligned with respect to the optical system (that is, the optical system including the electron gun 100, the condensing lens 200, the deflector 300, and the objective lens 400) that transfers the input electron beam IEB. For example, the structure specimen S may be arranged on one side of the wafer W on the stage 600.

The structure specimen S may include a plurality of samples. Each sample may include a coupon specimen of the structure of the semiconductor device. For example, each sample may include a coupon specimen of a memory repetition pattern structure, such as a pillar, a hole, a line, and/or space.

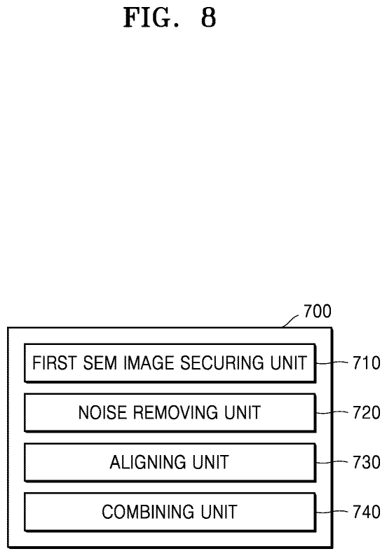

The processor 700 may process each SEM image of the wafer W and/or the structure specimen S to be inspected. The processor 700 may convert the SEM image into a gray level histogram, analyze the gray level histogram, calibrate the detector 530, and generate an image for 3D structure measurement. The processor 700 may obtain highly reproducible data by calibrating the detector 530 according to the pattern structure of the wafer W to be measured, and by post-processing the image. In addition, the processor 700 may remove noise from the SEM image, align the removed SEM images with the noise removed therefrom, and combine the aligned SEM images, as discussed herein. The configuration of the processor 700 is described below with reference to FIG. 8.

The processor 700 may include a computing device, such as a workstation computer, a desktop computer, a laptop computer, and a tablet computer. The processor 700 may be respectively configured as individual hardware, or as individual software included in one piece of hardware. The processor 700 may also include a simple controller, a complex processor, such as a microprocessor, a CPU, and a GPU, a processor configured by software, dedicated hardware or firmware. The processor 700 may include, for example, application-specific hardware, such as a digital signal processor (DSP), a field programmable gate array (FPGA), and an application specific integrated circuit (ASIC).

According to some embodiments, the operation of the processor 700 may be implemented as instructions stored on a machine-readable medium that may be read and executed by one or more processors. In this case, the machine-readable medium may include an arbitrary mechanism for storing and/or transferring information in a form readable by a machine (for example, a computing device). For example, the machine-readable medium may include read-only memory (ROM), random access memory (RAM), a magnetic disk storage medium, an optical storage medium, a flash memory device, electrical, optical, acoustical, or other different forms of radio signals (for example, a carrier wave, infrared signals, digital signals, or the like), and other arbitrary signals.

The processor 700 may include firmware, software, routines, and instructions that are configured to perform the operations described for the processor 700, or any process to be described below. However, this is for convenience of explanation, and it should be understood that the operation of the processor 700 may be caused by a computing device, a processor, a controller, or another device that executes firmware, software, routines, instructions, and the like.

FIG. 8 is a schematic block diagram of an example of the processor 700 in FIG. 7.

Referring to FIG. 8, the processor 700 may include a first SEM image securing unit 710, a noise removing unit 720, an alignment unit 730, and a combining unit 740.

The first SEM image securing unit 710 may receive, from the detector 530, the first SEM image generated by the detector 530. The input electron beam IEB irradiated from the electron gun 100 of the SEM 1000 toward the sample may be emitted from the sample as the emitted electrons EE, and the emitted electrons EE may be detected by the detector 530 to generate the first SEM image.

The first SEM image generated by the detector 530 may be transferred to the first SEM image securing unit 710. The first SEM image may include one frame image formed by the emitted electrons EE which are emitted by irradiating the input electron beam IEB onto all or a portion of the sample one time. For example, the first SEM image securing unit 710 may perform the operations disclosed in connection with operation S110 of FIG. 1.

The noise removing unit 720 may generate the plurality of second SEM images by removing noise from each of the plurality of first SEM images. The noise removing unit 720 may generate the plurality of second SEM images by removing noise for each of the plurality of first SEM images by using the machine learning. The second SEM image may include an image from which noise has been removed from the first SEM image including one frame image.

The noise removing unit 720 may use machine learning to remove noise from the first SEM image. The machine learning may use, for example, an auto-encoder/decoder. The auto-encoder/decoder may include the auto-encoder AE and the auto-decoder AD.

The auto-encoder AE may receive the first SEM image, and perform encoding (or compression) on the first SEM image. The auto-decoder AD may decode information in a compressed form with respect to the first SEM image that has been generated by the auto-encoder AE. By encoding/decoding the first SEM image 10 by using the auto-encoder/auto-decoder, noise of the first SEM image 10 may be removed. For example, the noise removing unit 720 may perform the operations disclosed in connection with operation S120 of FIG. 1.

The machine learning may be replaced by the auto-encoder/decoder as well as a characteristics learning model, such as CAE, VAE, and GAN.

The alignment unit 730 may align the plurality of second SEM images from which noise has been removed. The alignment unit 730 may set any one of the plurality of second SEM images 21 through 24 as reference images, set other second SEM images as input images, and align the reference image with the input image so that the MSE between the reference image and the input image is minimized while the input image is relatively moving with respect to the reference image.

The alignment unit 730 may arbitrarily set one of the plurality of second SEM images 21 through 24 as the reference image, and set another second SEM image except for the second SEM image set as the reference image, as the input image.

In addition, the alignment unit 730 may calculate the MSE while moving the second SEM image 22, which is the input image, in the first direction D1 or the second direction D2 with respect to the second SEM image 21, which is the reference image. The alignment unit 730 may calculate the MSE in the state where the second SEM image 21, or the reference image, overlaps the second SEM image 22, or the input image, and may calculate the MSE after the second SEM image 22, or the input image, is moved by one pixel in the first direction D1.

The alignment unit 730 may calculate the MSE for all movements of the second SEM image 22, or the input image, with respect to the second SEM image 21, or the reference image, and by comparing the MSE's that are calculated, may calculate the movement amount of the second SEM image 22, or the input image, that minimizes the MSE. Because the MSE means a difference between the second SEM image 21, or the reference image, and the second SEM image 22, or the input image, when the second SEM image 22, or the input image, is moved by the movement amount to minimize the MSE, the second SEM image 21, or the reference image and the second SEM image 22, or the input image, may be in an optimum alignment state.

The alignment unit 730 may calculate a movement amount at which the MSE is minimized for the reference image with respect to all input images. For example, the alignment unit 730 may perform the operations disclosed in connection with operation S130 of FIG. 1.

The combining unit 740 may generate the third SEM image by combining the plurality of second SEM images moved according to the movement amount at which the MSE is minimized, and the second SEM image that is the reference image. Because the third SEM image is obtained by removing noise from the first SEM images 11 through 14, which are single frames, before combining, and by combining after aligning the second SEM images 21 through 24 from which noise has been removed, a precise shift compensation between each of SEM images may be performed, and thus the SEM image of high quality without image blur or resolution deterioration may be obtained. For example, the combining unit 740 may perform the operations disclosed in connection with operation S140 of FIG. 1.

While the inventive concept has been particularly shown and described with reference to embodiments thereof, it will be understood that various change in form and details may be made therein without departing from the spirit and scope of the following claims.

What is claimed is:

1. A scanning electron microscope (SEM) image improvement method, the method comprising:
obtaining a plurality of first SEM images by using the SEM;
generating a plurality of second SEM images by removing noise from each of the plurality of first SEM images;
aligning the plurality of second SEM images; and
generating a third SEM image by combining the aligned plurality of second SEM images.

2. The method of claim 1, wherein each of the plurality of first SEM images is an image obtained by using a semiconductor process resultant product as a target.

3. The method of claim 2, wherein each of the plurality of first SEM images comprises one frame obtained by one-time irradiation of the SEM.

4. The method of claim 1, wherein the generating of the plurality of second SEM images by removing the noise comprises generating the plurality of second SEM images by removing the noise from each of the plurality of first SEM images by using machine learning.

5. The method of claim 4, wherein the machine learning comprises learning by using an auto-encoder/decoder, a convolution autoencoder (CAE), a variational autoencoder (VAE), or a generative adversarial network (GAN).

6. The method of claim 1, wherein the aligning of the plurality of second SEM images comprises:
setting any one of the plurality of second SEM images as a reference image, setting other second SEM images of the plurality of second SEM images as input images, and aligning the reference image and the input images such that a mean squared error (MSE) between the reference image and each of the input images is minimized while relatively moving the input images with respect to the reference image.

7. The method of claim 6, wherein the generating of the third SEM image comprises generating the third SEM image by combining the reference image with the input images moved to have a minimum MSE in relation to the reference image.

8. The method of claim 6, wherein the MSE is calculated using Formula 1 below:
$$M S E ( x , y ) = \frac{{{\sum }_{M \cdot N} [ Ref ( m , n ) - input ( m - x , n - y ) ]}^{2}}{M \cdot N} , \qquad Formula 1$$
wherein Ref(m, n) is a pixel value of the reference image at a coordinate (m, n), input (m−x, n−y) is a pixel value of the input image at a coordinate moved from the coordinate (m, n) by (x, y), M is the number of pixels in a first direction, and N is the number of pixels in a second direction,
wherein the first direction is a longitudinal axis direction of the reference image, and
wherein the second direction is a vertical axis direction of the reference image.

9. A scanning electron microscope (SEM) image improvement method, the method comprising:
obtaining a plurality of first SEM images, each including one frame, by using the SEM;
generating a plurality of second SEM images by removing noise from each of the plurality of first SEM images by using machine learning;
aligning the plurality of second SEM images; and
generating a third SEM image by combining the aligned plurality of second SEM images.

10. The method of claim 9, wherein each of the plurality of first SEM images is an image obtained by using a semiconductor process resultant product as a target.

11. The method of claim 9, wherein the machine learning comprises learning by using an auto-encoder/decoder, a convolution autoencoder (CAE), a variational autoencoder (VAE), or a generative adversarial network (GAN).

12. The method of claim 9, wherein the aligning of the plurality of second SEM images comprises:
setting any one of the plurality of second SEM images as a reference image, setting other second SEM images of the plurality of second SEM images as input images, and aligning the reference image and the input images such that a mean squared error (MSE) between the reference image and each of the input images is minimized while relatively moving the input images with respect to the reference image.

13. The method of claim 12, wherein the generating of the third SEM image comprises generating the third SEM image by combining the reference image with the input images moved to have a minimum MSE in relation to the reference image.

14. The method of claim 13, wherein the MSE is calculated by using Formula 1 below:
$$M S E ( x , y ) = \frac{{{\sum }_{M \cdot N} [ Ref ( m , n ) - input ( m - x , n - y ) ]}^{2}}{M \cdot N} , \qquad Formula 1$$
wherein Ref(m, n) is a pixel value of the reference image at a coordinate (m, n), input (m−x, n−y) is a pixel value of the input image at a coordinate moved from the coordinate (m, n) by (x, y), M is the number of pixels in the first direction, and N is the number of pixels in the second direction,
wherein the first direction is a longitudinal axis direction of the reference image
wherein the second direction is a vertical axis direction of the reference image.

15. A scanning electron microscope (SEM) image improvement method, the method comprising:
obtaining a first SEM image by using a semiconductor process resultant product as a target by using the SEM;
generating a plurality of second SEM images by removing noise from each of the first SEM images by using machine learning;
aligning the plurality of second SEM images; and
generating a third SEM image by combining the aligned plurality of second SEM images.

16. The method of claim 15, wherein each of the plurality of first SEM images comprises one frame obtained by one-time irradiation of the SEM.

17. The method of claim 15, wherein the machine learning comprises learning by using an auto-encoder/decoder, a convolution autoencoder (CAE), a variational autoencoder (VAE), or a generative adversarial network (GAN).

18. The method of claim 15, wherein the aligning of the plurality of second SEM images comprises:
setting any one of the plurality of second SEM images as a reference image;
setting other second SEM images of the plurality of second SEM images as input images;
calculating a movement amount that minimizes a mean squared error (MSE) of the reference image and each of the input images while relatively moving the input images with respect to the reference image; and
aligning the input images moved by the movement amount with the reference image.

19. The method of claim 15, wherein the generating of the third SEM image comprises generating the third SEM image by combining the reference image with the input images moved to have a minimum MSE in relation to the reference image.

20. The method of claim 18, wherein the MSE is calculated by using Formula 1 below:
$$M S E ( x , y ) = \frac{{{\sum }_{M \cdot N} [ Ref ( m , n ) - input ( m - x , n - y ) ]}^{2}}{M \cdot N} , \qquad Formula 1$$
wherein Ref(m, n) is a pixel value of the reference image at a coordinate (m, n), input (m−x, n−y) is a pixel value of the input image at a coordinate moved from the coordinate (m, n) by (x, y), M is the number of pixels in the first direction, and N is the number of pixels in the second direction,
wherein the first direction is a longitudinal axis direction of the reference image, and
wherein the second direction is a vertical axis direction of the reference image.
